(19) United States
(12) Patent Application Publication
(10) Pub. No.: US 2017/0201285 A1
(43) Pub. Date: Jul. 13, 2017

(54) PROTECTIVE COVER FOR ELECTRONIC DEVICE

(71) Applicant: GoDirectInc.com, Inc., Chino, CA (US)

(72) Inventor: Warren Liu, Chino, CA (US)

(21) Appl. No.: 15/374,469

(22) Filed: Dec. 9, 2016

Related U.S. Application Data
(60) Provisional application No. 62/278,379, filed on Jan. 13, 2016.

(51) Int. Cl. H04B 1/3888

(52) U.S. Cl. CPC H04B 1/3888

(57) ABSTRACT

The protective cover for an electronic device is an apparatus that is provided as a means to protect in electronic device from the wear and tear of daily usage without limiting the portability of the electronic device or the accessibility of the electronic devices hardware keys, screen, or charging ports. The apparatus accomplishes this through the use of sidewalls and a rear panel. The sidewalls and rear panel house the electronic device and protect it from everyday wear and tear. This protects the electronic device from accidental damage. Optionally, the cover may incorporate a front panel that allows access to the screen of the device while protecting the screen. As another option the protective cover may incorporate one or more corner bumpers to protect the device from shock when dropped on a corner. The sidewalls of the cover may comprise inner stiff sidewalls and outer flexible sidewalls. Alternatively, the sidewalls may comprise a stiff material co-molded with a flexible material.

### CROSS REFERENCE TO RELATED APPLICATION

The subject application claims priority to U.S. Provisional Application Ser. No. 62/278,379 filed Jan. 13, 2016 entitled “PROTECTIVE COVER FOR ELECTRONIC DEVICE”, the entirety of which is incorporated herein by reference.

### TECHNICAL FIELD

The present invention relates generally to an electronic device enclosure, more specifically to a protective cover that shields an electronic device from wear and tear while allowing a user to use the inserted device.

### BACKGROUND

With the advent of new technology, people rely more on mobile electronic devices to enhance and facilitate their daily activities. Many of these mobile electronic devices, such as tablet PCs and smart phones, combine the function of several electronic devices into a single device with a wide range of functionality. While these mobile electronic devices have become essential for managing the daily lives of many people, their daily usage will often cause wear and tear on the device itself. In most situations, the signs of wear are merely cosmetic. But if a user were to drop the device, irreparable damage can be caused to the mobile device. This can often lead to expensive repair costs; more commonly, it will require complete replacement of the electronic device.

Although several systems and methods for protecting these mobile devices from normal wear and tear and accidental damage already exist, these systems often limit the functionality of the mobile device. These existing systems are generally designed to be simplistic enclosures that envelope the mobile device, functioning as a protective barriers. The disadvantage with these systems is that they generally provide either an aesthetic, stiff material with limited protection against drops or a flexible material that offers protection against drops but provides limited aesthetic value. Another problem is the lack of accessibility of charging ports and hardware keys in certain systems. Many systems lack adequate protection for the corners of devices in the event that the device is dropped on its corner. Other systems that are formed of a flexible material may provide a deformable, flexible material to absorb shock of a drop, but lack a frame formed from a stiff material to distribute the shock and ensure that the flexible material retains its original shape during extended use to protect an electronic device Other systems protect both the front screen and rear portion of an electronic device. But they do not allow the user to view decorative elements on the rear of the device through a clear, protective panel. In other instances, existing systems may protect devices with a cover, but lack the ability to store credit cards, ID cards, or other cards or objects in a storage compartment incorporated in the cover. And, even if current systems allow such storage, they do not allow storage of such cards or objects in an accessible, enclosed compartment that shields the cards or objects from view.

The above-described background is merely intended to provide a contextual overview of some current issues, and is not intended to be exhaustive. Other contextual information, including other problems with conventional implementations and techniques, and corresponding benefits of the various solutions described herein, may become further apparent upon review of the following detailed description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In view of the background, it is therefore an object of the present invention to provide a protective cover for an electronic device that is able to protect the electronic device from the wear and tear of daily usage while also providing enhanced protection when a device is dropped resulting in the device landing on its corner. This may be accomplished by providing a protective cover incorporating one or more corner bumpers that comprises a plurality of air pockets between an electronic device and a flexible material forming the cover.

It is another object of the present invention to provide a two-part protective case including an inner case formed of a stiff material and an outer case formed of a flexible material. The inner case may include four parallel sidewalls that may surround the sides of the electronic device and a rear panel attached to the four sidewalls also formed of a stiff material. In such an embodiment, the outer case may include four sidewalls formed of a flexible material that are shaped and sized in a manner allowing attachment of the outer case on the outside of the inner case such that the stiff sidewalls of the inner case are surrounded by the flexible sidewalls of the outer case. In this manner the device may be enclosed, and the protective cover may shield the device from dropping damage through absorption of shock by the flexible outer walls, while the inner side walls of the cover distribute the shock to a greater surface area of the device to prevent a significant shock to a small surface area of the device.

It is another object of the present invention to provide a protective cover including a transparent scratch-resistant rear panel connected to each of plurality of sidewalls such that the decorative nature of the rear side of an electronic device may be viewed through the rear panel. Or in the alternative, if the device has a rear screen, that rear screen may be viewed through the transparent rear panel while still providing protection for the rear screen.

Yet another object of the invention is to provide a compartment with a slideable cover wherein a plurality of credit cards, identification cards, or other cards or objects may be stored. In such a compartment, the invention provides a compartment and slideable cover formed such that the stored items may be hidden from view when the compartment is closed.

These and other embodiments are described in more detail below.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a front perspective view of a protective cover showing a first embodiment of the present invention.

FIG. 2 is a rear perspective view of the same embodiment.

FIG. 3 is a left side plan view of the same embodiment.

FIG. 4 is a right side plan view of the same embodiment.

FIG. 5 is a top plan view of the same embodiment.

FIG. 6 is a bottom plan view of the same embodiment.

FIG. 7 is a front plan view of the same embodiment.

FIG. 8 is a rear plan view of the same embodiment.

FIG. 9 is a rear perspective view of a protective cover showing a second embodiment of the present invention, showing a slideable cover and kickstand in open positions.

FIG. 10 is a front perspective view of the same embodiment.

FIG. 11 is a rear perspective view of the same embodiment, showing a slideable cover and kickstand in closed positions.

FIG. 12 is a left side plan view of the same embodiment.

FIG. 13 is a right side plan view of the same embodiment.

FIG. 14 is a top plan view of the same embodiment.

FIG. 15 is a bottom plan view of the same embodiment.

FIG. 16 is a rear plan view of the same embodiment.

FIG. 17 is a front plan view of the same embodiment.

FIG. 18 is a front perspective view of a protective cover showing a third embodiment of the present invention.

FIG. 19 is a rear perspective view of the same embodiment.

FIG. 20 is a left side plan view of the same embodiment.

FIG. 21 is a right side plan view of the same embodiment.

FIG. 22 is a top plan view of the same embodiment.

FIG. 23 is a bottom plan view of the same embodiment.

FIG. 24 is a front plan view of the same embodiment.

FIG. 25 is a rear plan view of the same embodiment.

FIG. 26 is a cutaway view of a sidewall and a portion of the rear panel in one embodiment of a protective cover.

FIG. 27 is a cutaway view of a sidewall and a portion of the rear panel in another embodiment of a protective cover.

FIG. 28 is a cutaway view of a corner bumper in one embodiment of a protective cover.

FIG. 29 is a cutaway view of a corner bumper in another embodiment of a protective cover.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As an overview of the various embodiments presented herein, to correct for the above-identified deficiencies and other drawbacks of traditional protective covers, various embodiments are described herein to facilitate protection of electronic devices.

For simplicity of explanation, the protective covers are depicted and described as a group of elements. It is to be understood and appreciated that the various embodiments are not limited by the elements illustrated and/or by the specific illustrated arrangements of elements. For example, elements may be combined in differing combinations or physical relationships, and with other elements not presented or described herein. Furthermore, not all illustrated elements may be required to implement the inventions.

Described herein are systems, methods, articles of manufacture, and other embodiments or implementations that can facilitate protection of electronic devices. Such devices may be any type of device such as: a mobile handset, a laptop computer, a tablet computer, a handheld device, or the like, including but not limited to various generations of Apple iPad, Apple iPhone, Amazon Kindle, Nook, Acer Iconia Tab Tablet, Samsung Galaxy, Asus Transformer Pad, Lenovo IdeaPad, Lenovo ThinkPad, LG G-Slate, Motorola DROID, Sony S1, etc.

In one embodiment, described herein is a protective cover for an electronic device that is able to protect the electronic device from the wear and tear of daily usage while also providing enhanced protection when a device is dropped resulting in the device landing on its corner. This may be accomplished by providing a protective cover incorporating one or more corner bumpers that comprises a plurality of air pockets between an electronic device and a flexible material forming the cover.

According to another embodiment, a two-part protective case including an inner case formed of a stiff material and an outer case formed of a flexible material is provided. The inner case may include four parallel sidewalls that may surround the sides of the electronic device and a rear panel attached to the four sidewalls also formed of a stiff material. In such an embodiment, the outer case may include four sidewalls formed of a flexible material that are shaped and sized in a manner allowing attachment of the outer case on the outside of the inner case such that the stiff sidewalls of the inner case are surrounded by the flexible sidewalls of the outer case. In this manner the device may be enclosed, and the protective cover may shield the device from dropping damage through absorption of shock by the flexible outer walls, while the inner side walls of the cover distribute the shock to a greater surface area of the device to prevent a significant shock to a small surface area of the device.

According to yet another embodiment, described herein is a protective cover including a transparent scratch-resistant rear panel connected to each of plurality of sidewalls such that the decorative nature of the rear side of an electronic device may be viewed through the rear panel. Or in the alternative, if the device has a rear screen, that rear screen may be viewed through the transparent rear panel while remaining protected by the rear panel.

Yet another embodiment provides a compartment with a slideable cover wherein a plurality of credit cards, identification cards, or other cards or objects may be stored. In such a compartment, the invention provides a compartment and slideable cover formed such that the stored items may be hidden from view when the compartment is closed.

These and other embodiments or implementations are described in more detail below with reference to the drawings.

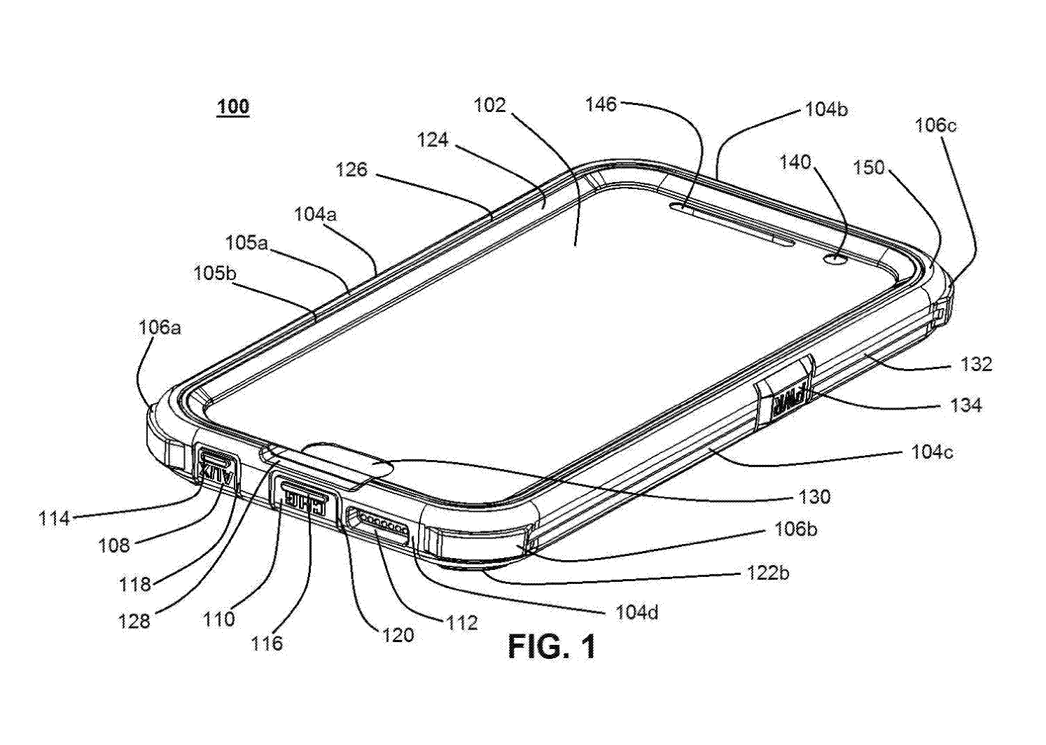

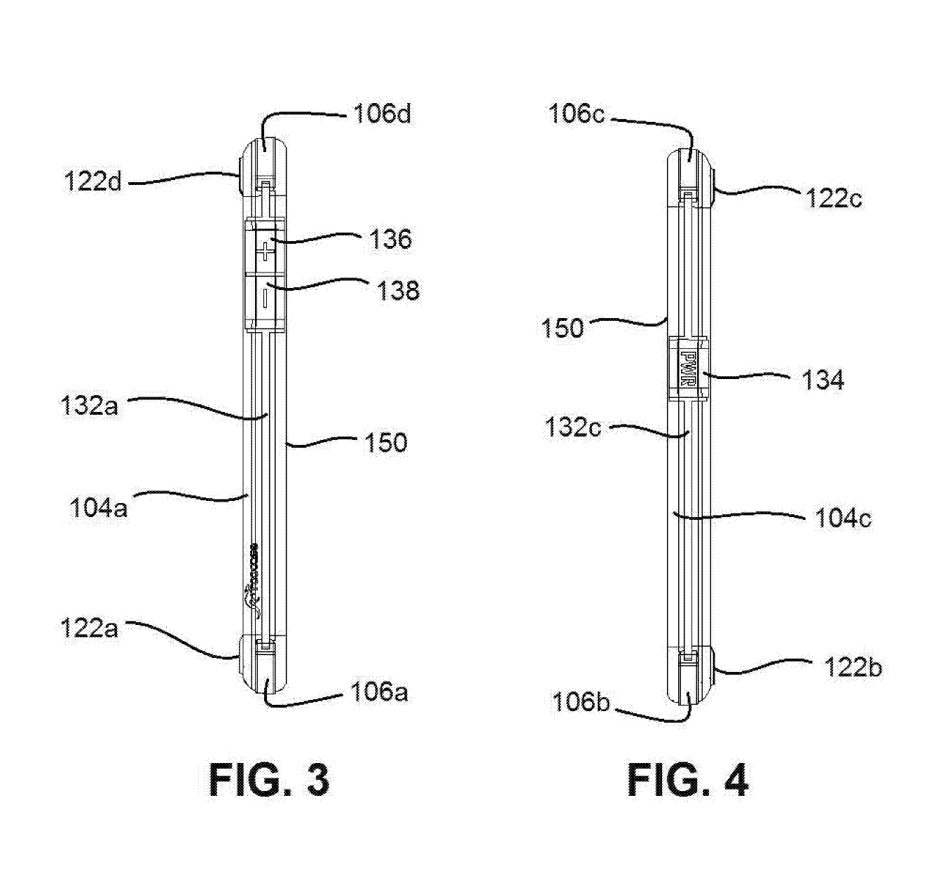

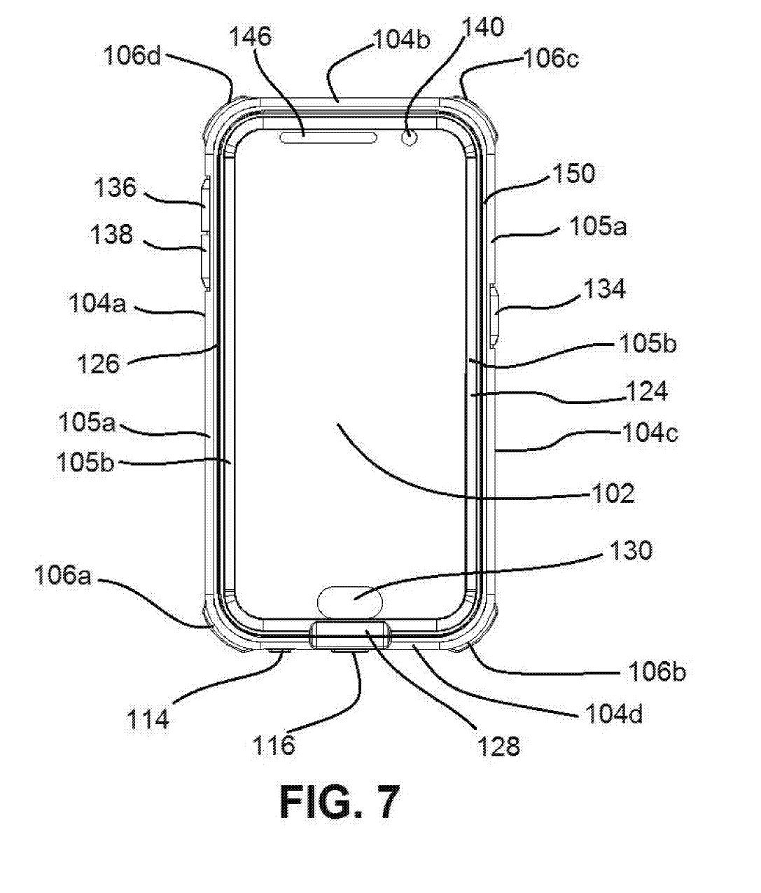

Referring to FIGS. 1-8, a first embodiment of a protective cover 100 for an electronic device (not shown) is illustrated. The protective cover 100 may comprise a front panel 102 and four sidewalls 104a-104d. The front panel 102, may comprise various cutouts to allow access to buttons, keys, sensors, inputs, outputs, or other features of the electronic device. As illustrated in FIG. 1, exemplary cutouts include a button cutout 130 for allowing access to a button of the electronic device, a camera cutout 140 for allowing access to a camera of the device, and the speaker cutouts 146 for allowing access to the speaker of the device. In this manner various signals may be transmitted from the device through the front panel 102 to the user of the device or, in the alternative, from the user of the device through the front panel 102 to the device. Ideally, front panel 102 comprises a material that is both transparent and allows the user's touch to be transmitted to a touch sensitive screen of the device located on the opposite side of the front panel 102 from the user's fingers, e.g., below front panel 102 as illustrated in FIG. 1.

The front panel 102 may be surrounded fully or partially by a beveled rim 124, which provides an added level of protection for the device and the screen of the device, as well as for the front panel 102. Raised ridge 150 may also be provided at the highest point of beveled rim with respect to the front panel 102. Raised ridge 150 may be formed about the entire perimeter of beveled rim 124 or may be formed only about portions of beveled rim 124 to provide either a continuous support structure or a system of supports for cover 100 when dropped or placed on a surface with front panel 102 facing the surface. A recessed area 128 may be formed in beveled rim 124 and raised ridge 150 to allow ease of manipulation of the button below button cutout 130 (or other button cutouts or cutouts for fingerprint readers or other input devices) by the user's thumb or finger when using covers in which the beveled rim 124 or raised ridge 150 would otherwise interfere with or render uncomfortable such manual manipulation of the relevant button. As can be seen in the FIGS., in the exemplary illustrated embodiment of cover 100, the recessed area 128 is slightly wider than the button cutout 130 due to the width and/or angle of the digit with which the user manipulates the relevant button. Such recessed areas may be provided at other advantageous locations about the perimeter of front panel 102 or rear panel 144. Beveled rim 124 may be of various heights, but is provided to allow a separation between the front panel 102 and a flat surface (not illustrated) when the protective cover is dropped onto the flat surface. In such circumstances, beveled rim 124 will raise the front panel 102 above such a flat surface sufficiently to protect the front panel 102 from an impact with the flat surface. Beveled rim 124 may be a portion of sidewalls 104a, 104b, 104c, and 104d.

Each of the sidewalls 104a-d may be comprised of an inner stiff sidewall and an outer flexible sidewall, where the inner stiff sidewalls together form a significant portion of an inner case and the outer flexible sidewalls together form a significant portion of an outer case. In the embodiment of FIG. 1, only one such pair of sidewalls is labeled for clarity, i.e., inner stiff sidewall 105b and outer flexible sidewall 105a. Outer flexible sidewall 105a may be formed to interlock with inner stiff sidewall 105b, such that inner stiff sidewall 105b is retained in close proximity with outer flexible sidewall 105a during ordinary use of the electronic device for which the protective cover 100 is provided. A seam 126 illustrates where the inner stiff sidewalls meet with the outer flexible sidewalls, including the meeting of inner stiff sidewall 105b and outer flexible sidewall 105a, and extends about the peripheral border of front panel 102 and beveled rim 124. In some embodiments, where portions of outer flexible sidewalls have a varying height profile or do not extend entirely to the height of the inner stiff sidewalls, portions or all of seam 126 may be found in a location lateral to the inner stiff sidewalls, rather than the illustrated location. As illustrated in this embodiment, beveled rim 124 is a portion of inner stiff sidewall 105b. However, it is envisioned that in certain embodiments, rim 124 maybe a portion of the outer flexible sidewall 105a.

By way of example, outer flexible sidewall 105 a maybe formed of thermoplastic polyurethane (“TPU”), silicone or other similar materials with a similar impact absorbing qualities. And inner stiff sidewall 105b may be formed of polycarbonate (“PC”) or other similar materials with similar stiffness properties. In the embodiment formed of TPU and PC, the TPU absorbs the impact of a drop, and the PC forms a stiff inner frame to retain the shape of the protective cover. Certain other types of covers may not work as well in protecting electronic devices from shock as the inventive device disclosed herein. For example, an all TPU protective cover may not have the necessary stiffness to protect the device from the types of drops from which the inventive protective cover can protect the device. And an all PC protective cover may be too stiff to absorb the impact to the device when dropped in the same fashion as the inventive device. However the combination of an inner stiff sidewall 105b made of PC and an outer flexible sidewall 105a formed of TPU provides both impact absorption and a stiff frame that does not excessively deform upon impact. As a further advantage of using TPU to form the outer flexible sidewall, TPU allows for the outer flexible sidewall to be folded or wrapped around the inner stiff sidewall while the inner stiff sidewall retains its protective form when the two sidewall portions are mated together and interlocked for protection of an electronic device. Moreover, the use of TPU to form the outer flexible sidewall allows the inclusion of various port covers, tabs, and seals, as well as button covers that are flexible and that may be sealed to protect against the entry of liquids, dirt, dust, or other materials that may damage various ports, sensors, keys, buttons, or other features of an electronic device where foreign materials may interfere with the intended operation of the device.

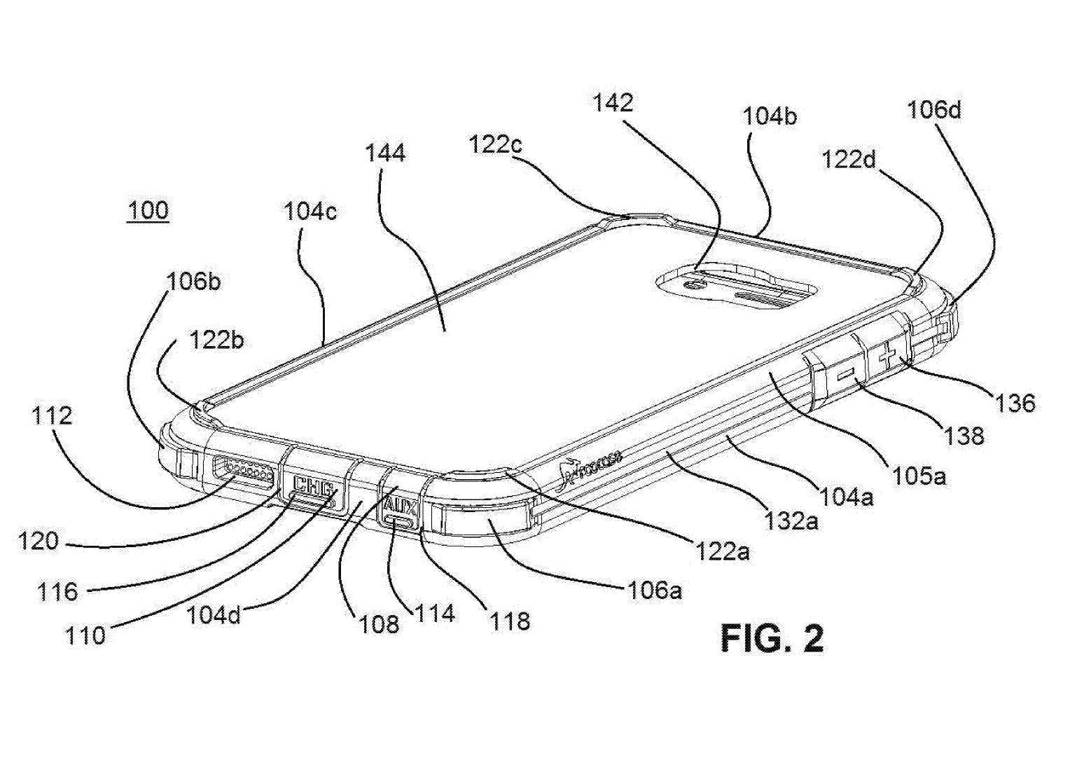

For example, as illustrated in FIGS. 1-2, port cover 108, port cover 110, and button covers 134, 136, and 138, as well as grip tabs 114 and 116 may be formed of the flexible material that also forms the outer flexible sidewall. In this example, port cover 108, labeled AUX, covers a port for an auxiliary input. Grip tab 114 allows the user to manually open port cover 108 and obtain access to the auxiliary port or to close port cover 108 and thereby protect the auxiliary port. Similarly, grip tab 116 allows the user to manually open port cover 110, labeled CHG, which may protect the charging port of the device. A cavity 118 may extend about three sides of port cover 108 to allow the cover 108 to be opened by bending the flexible material along the fourth side of cover 108. A cavity 120 about three sides of cover 110 allows similar manipulation of cover 110. Grip tab 116 will allow the user to manually open and close support cover 110 to gain access to or protect the charging port. Port cover 108 and/or port cover 110 may be formed with one or more small bumps on the edge that meets sidewall 104d, such that the bumps will assist with retaining the port covers in a closed position without sealing the port cover to sidewall 104d. In such instances, it may be desirable to form the portion of sidewall 104d that interacts with these small bumps with a small depression or series of small depressions into which the bumps may be inserted when the port covers are closed. Or, in the alternative, the bodies of port covers 108 and 110 may be enlarged sufficiently to form a seal about their edges when closed. Similarly, the protective cover may comprise an inner membrane or inner plug that is attached to the cover and pliable, but stiff enough to seal an opening. Likewise, a membrane may be provided for the device's speakers, headphone port, or other orifices that require sound or electronic transmission wherein, the membrane prevents foreign materials such as water or dirt from entering the port or orifice, but also allows the port or orifice to function in its intended purpose, for example, by allowing sound transmission or by allowing electrical signal transmission. In certain embodiments, it may be desirable to extend a wall of stiff material from an inner stiff sidewall 105b into all or a portion of the volume identified as cavities 118 and/or 120. Such a wall may provide for additional impact protection and sealing of various openings in the case, such as those openings corresponding to port covers 108 and 110. Additional openings in the case, such as speaker opening 112, may be provided with a wall of stiff material about the periphery of the opening extending outward from an inner stiff sidewall towards the outer surface of an outer flexible sidewall. Such a wall of stiff material can provide benefits such as additional impact protection and the ability to more firmly grasp an inserted sealing plug (not illustrated) to seal the opening against the environment external to the protective cover 100.

Button cover 134 labeled PWR in FIG. 1, which may be a cover for the power button and button covers 136 and 138, labeled + and − in FIG. 2, which may be covers for the volume buttons, may also be formed of a flexible material such as TPU. Button covers 134, 136 and 138 may be sealed about their entire perimeters to a sidewall, such as sidewall 104c or 104a, or they may be formed with one or more slits at various points on the perimeter to permit manipulation of covers 134, 136, and 138 with less force. Forming button covers 134, 136 and 138 with a seal about the perimeter allows for an enhanced protection of the device buttons that are being covered. In some embodiments, the outer surface of button covers may be raised with respect to the profile of the sidewall to allow ease of access to certain users, e.g., users wearing gloves or other hand coverings, users with medical conditions or impairments that may not be able to manipulate button covers that are flush with the sidewall, machine manipulations of buttons, etc.

Sidewalls 104a-d may also be formed with a slot, such as slots 132a and 132c, to enhance gripability of the cover 100. As illustrated in FIGS. 1 and 2, slots 132a and 132c extend from one end of the sidewall to the opposite end of the sidewall and are formed as a trench having right angles separating its bottom and walls. It may be desirable to form the slots 132a and 132c with differing profiles, including v-shaped or curved profiles, or to form the slots 132a and 132c as a series of separated slots that do not extend the entire length of the sidewall.

Various openings extending through both the inner stiff sidewall and the outer flexible sidewall may be provided in the sidewalls of cover 100. For example, as illustrated in FIG. 1, a speaker opening 112 maybe provided in sidewall 104d. The speaker opening 112 may provide access to a speaker of the device such as that sound may be transmitted from the speaker to the user without interference by the protective cover 100. The speaker opening 112 may be provided with a cover or a plug for sealing, in situations where it may be desirable to prevent matter from outside the protective cover from entering into the speaker of the device.

Referring to FIGS. 1-8, the cover 100 may also be formed with a plurality of corner bumpers such as corner bumpers 106a, 106b, 106c, and 106d. As illustrated, sidewall 104a is adjoined with sidewall 104d by way of corner bumper 106a. Sidewall 104d is adjoined with sidewall 104c through corner bumper 106b. Sidewall 104b is adjoined to sidewall 104c by corner bumper 106c. And sidewall 104b is adjoined to sidewall 104a by corner bumper 106d. Corner bumpers 104a-d may be formed using the same flexible material used to form the outer flexible sidewall 105a, for example, TPU or silicone.

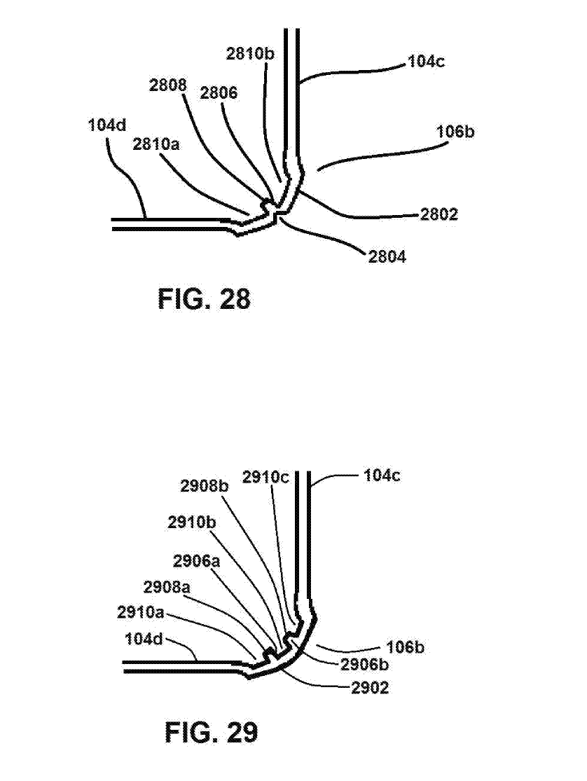

FIGS. 28-29 show cutaway views of exemplary corner bumpers when viewed from the front plane of the protective cover 100, looking toward the rear plane of protective cover 100. As illustrated in FIG. 28, an exemplary sidewall 104d is attached to an exemplary sidewall 104c by membrane (or material layer) 2802 of corner bumper 106b. Corner bumper 106b comprises at least an outer membrane 2802 that extends from sidewall 104c to sidewall 104d. An inner wall 2806 extends from membrane 2802 into the cavity formed by membrane 2802 towards an electronic device that may be inserted into the cover. The wall 2806 terminates on its opposite end at surface 2808. Surface 2808 and wall 2806 may be formed such that the wall 2806 extends the entire distance from the membrane 2802 to an inserted electronic device. Or wall 2806 and surface 2808 may be formed such that they do not extend entirely from membrane 2802 to an inserted electronic device. Wall 2806 divides the volume between an electronic device and membrane 2802 into a plurality of cavities such as cavities 2810a and 2810b. It is preferably to provide a plurality of cavities within a corner bumper, rather than a single cavity. A single cavity without a dividing wall 2806 may permit the membrane 2802 to deform excessively when impacted. An excessive deformation of membrane 2802 may drive membrane 2802 into the surface of an inserted electronic device, such that the shock of an impact may be transmitted directly to the device in a relatively small impact area or zone. But, when a plurality of cavities are formed, an impact may be spread to the portions of the membrane about the zone of an impact, including the sidewalls and any portion of surface 2808 that may be in contact with or driven into an inserted electronic device. The embodiments disclosed herein lessen the risk of such impacts by providing a plurality of cavities separated by a wall 2806. In such embodiments, before the membrane is driven into the corner of an inserted electronic device, it is preferable that the surface 2808 comes into contact with the corner of an inserted electronic device, thereby forming a sealed or partially sealed cavity, e.g. 2810a or 2810b, between membrane 2802 and the corner of the inserted electronic device. Forming a sealed or partially sealed cavity will allow the air pressure in the cavity to increase as the membrane deforms, thereby spreading a portion of the shock to a larger surface of the inserted electronic device and reducing the risk that any particular impact causes a critical shock that would damage the inserted device. Additionally, the presence of wall 2806 allows for transmission of a portion of the shock to an inserted electronic device through surface 2808. In many instances, this will spread the shock of the impact over a larger portion of the surface of the electronic device than if the membrane 2802 were permitted to be driven directly into the inserted electronic device by the impact. In some instances, even with the presence of wall 2806, the membrane may be driven into the surface of an inserted electronic device by a hard impact. Yet, even in such circumstances, the presence of a plurality of cavities and wall 2806 is considered to be beneficial for purposes of spreading the shock of at least a portion of the impact over a larger surface area of the inserted electronic device. Further, as can be seen in FIGS. 28 and 29, the portions of the membrane 2802 and 2902 that are attached to the sidewalls may be formed to extend laterally beyond the profile of the sidewall in a direction parallel with rear plane 2614 or 2714. Extending the membrane in this manner increases the chance that dropping the device will result in an initial impact upon the corner bumper that diverts a portion or all of the shock away from the relevant sidewall 104a, 104b, 104c or 104d, and into the corner bumper, thereby allowing the corner bumper to spread a significant impact over a wider area or allowing the corner bumper to completely divert a less significant impact from the sidewall to the corner bumper. Protrusion of the membrane in this manner may also lessen the possibility that an impact will result in depression of one of the button covers or a direct strike on a grip tab, port cover, or other opening where an inserted electronic device may be less protected from an impact.

A divot 2804 extending partially through membrane 2802 or caused by an intentional deformation of membrane 2802 may divide the membrane 2802 into a plurality of impact zones, one adjacent to sidewall 104c and another adjacent to sidewall 104d. The divot 2804 may also be placed in a position that will prevent a direct impact on wall 2806. Such a direct impact on wall 2806 would be likely to focus an impact and drive wall 2806 directly into the surface of an inserted electronic device. By placing the divot 2804 on the opposite side of membrane 2802 from the intersection of the membrane 2802 and wall 2806, it will be possible, in certain instances, to redirect the impact to the plurality of impact zones of membrane 2802, thereby obtaining the shock-spreading advantages of cavities 2810a and 2810b and membrane 2802.

Referring now to FIG. 29, another embodiment of a corner bumper is illustrated. In such an embodiment, it may also be advantageous to provide for three or more cavities 2910a, 2910b, 2910c, each having the shock-spreading advantages of cavities 2810a and 2810b, within the corner bumper 106b or any corner bumper. As illustrated in FIG. 29, sidewall 104c is attached to sidewall 104d through corner bumper 106b. Corner bumper 106b is formed of a membrane (or material layer) 2902 extending from sidewall 104d to sidewall 104c. In the embodiment illustrated in FIG. 29, walls 2906a and 2906b are formed between the membrane 2902 and an inserted electronic device. As with the embodiment of FIG. 28, in the embodiment of FIG. 29, the walls 2906a and 2906b may be formed to extend partially from the membrane 2902 to an inserted electronic device, such that surfaces 2908a and 2908b are in direct contact with a corner area of the electronic device when the membrane 2902 is not deformed. Or the walls 2906a and 2906b maybe formed to extend only a portion of the distance from membrane 2902 to an inserted electronic device. In such an embodiment, surface 2908a and surface 2908b would not be in direct contact with the electronic device unless the protective cover was dropped, and the drop impacted corner bumper 106b with sufficient force to deform the membrane 2902 such that one or more of surfaces 2908a or 2908b was driven into direct contact with the corner of an inserted electronic device.

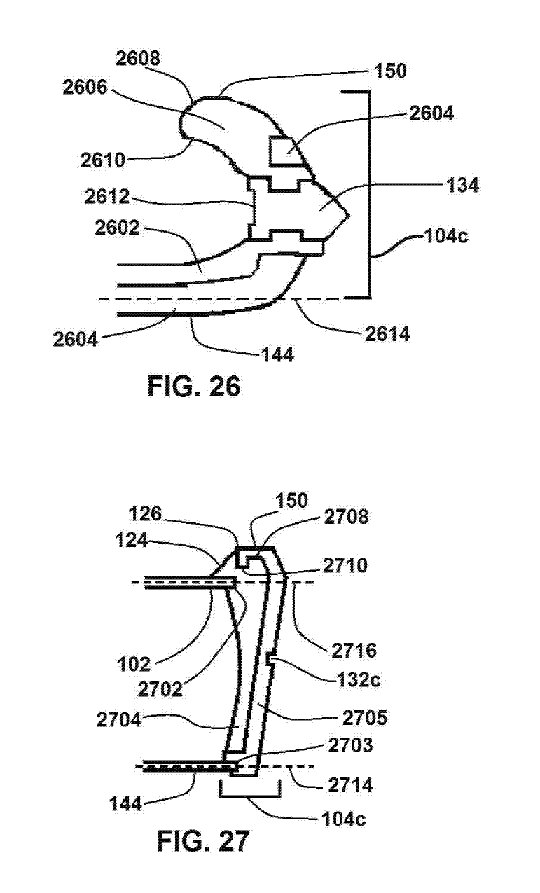

Referring now to FIGS. 1-8, cover 100 may comprise a rear panel 144, which may be formed of a transparent or opaque material. In this embodiment, it is preferable to form panel 144 of a transparent material, to allow a user to view the ornamental features of the rear portion of an inserted device, or to view a rear display on an inserted device. Rear panel 144 may define a rear plane 2614 or 2714 (see FIGS. 26, 27) of the cover 100. Rear panel 144 is surrounded on its periphery by sidewalls 104a, 104b, 104c, 104d, and corner bumpers 106a, 106b, 106c, and 106d. In certain embodiments of the invention directed to use with electronic devices having a curved or angular rear surface, rear panel 144 may be formed with a shape that is curved, angular, or has other features that do not easily define a rear plane. Such embodiments remain within the scope of the invention disclosed herein.

In this embodiment, it is preferable to form both front panel 102 and rear panel 144 with transparent materials. Front panel 102 provides protection for a display screen of an inserted electronic device, and should provide the user with the ability to view and interact with a touchscreen, when an inserted electronic device has touchscreen capabilities. To provide such capabilities, it is desirable to form the front panel 102 using materials such as polyethylene terephthalate (“PET”) or tempered glass. It is preferable to form front panel 102 with a scratch resistance of at least 5H on the pencil hardness scale. Using PET to form front panel 102 also increases the antiglare and anti-fingerprint properties of panel 102 to enhance visibility of the screen of an inserted electronic device after normal usage of the cover 100. PET is an option, but may not be the optimal material for forming the rear panel 144. Instead, it may be desirable to form the rear panel 144 using a transparent acrylic. Such an acrylic material should be much harder than PC and will often provide superior transparency and wear characteristics when compared to PC. Acrylic is also harder and tougher than PET, which is often formed in a thinner layer than acrylic panels. However, acrylic does not provide the same level of touch sensitivity as PET. Thus, while it is preferable to use acrylic in many instances for rear panel 144, acrylic would not be an appropriate material for front panel 102 if the cover 100 is to be used with an electronic device having a touch sensitive screen.

Rear panel 144 may comprise one or more cutouts, such as camera cutout 142. Cutouts in the rear panel may allow interaction with various functionalities, buttons, keys, sensors, inputs, and outputs of an inserted electronic device. Camera cutout 142, for example, was provided to allow a camera of an inserted electronic device as well as flash mechanism and potentially a microphone to allow an inserted electronic device to function in the manner that such functions and features would without a cover 100. One or more ridges 122a, 122b, 122c, and 122d may be provided about the periphery of rear panel 144. As illustrated in FIG. 2, raised ridges 122a-d are provided such that one of the raised ridges is placed near each of the corners of the protective cover 100. In a preferred embodiment each of ridges 122a-d will extend approximately 1 mm from the surface of the rear panel, to raise the rear panel approximately 1 mm above a flat surface when the cover 100 is laid on a flat surface on ridges 122a-d.

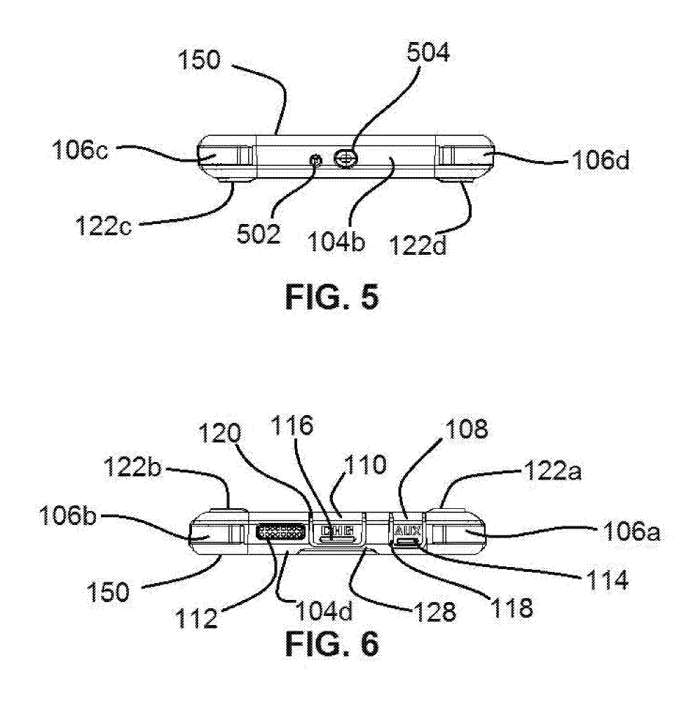

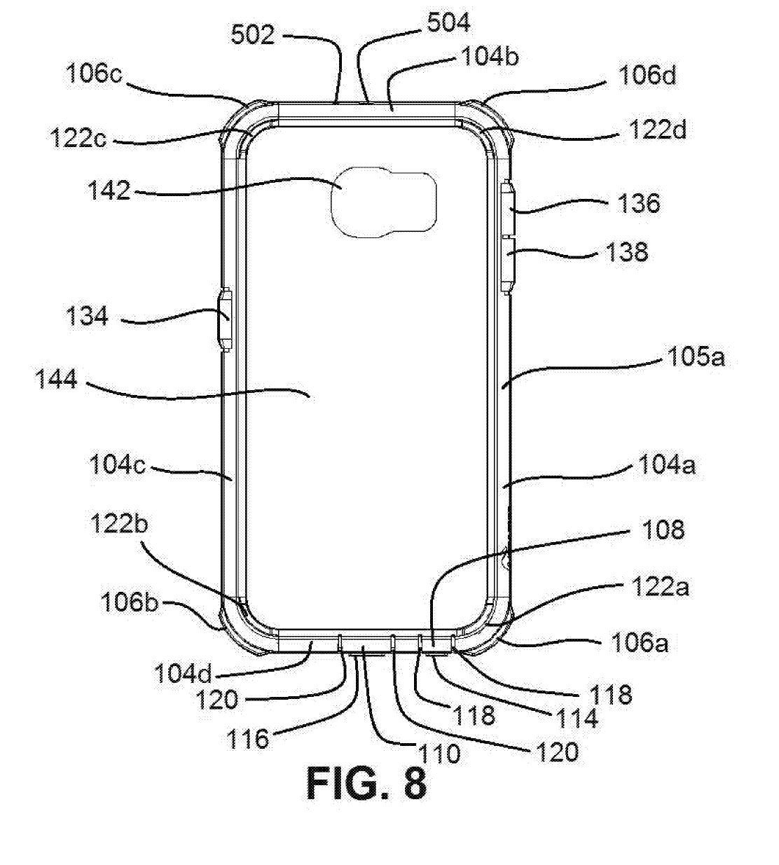

Referring to FIGS. 5 and 8, cover 100 may also comprise further openings, such as openings 502 and 504. Such openings may be provided through one of sidewalls 104a-d, to allow a user of cover 100 to access various features, outputs, or inputs of an electronic device inserted in cover 100. For example, opening 504 may be configured to allow transmission of signals by an infrared transmitter, and opening 402 may be configured to allow unrestricted use of a microphone on the electronic device.

Referring to FIGS. 1-8, in a preferred embodiment, cover 100 is 82.12 mm wide and 154.97 mm long, with a depth of 13.0 mm, while the width of opening 502 is 2.98 mm, the width of opening 504 is 5.98 mm, the width of button cover 134 is 16.01 mm, the distance from one end of button cover 136 to the opposite end of button cover 138 is 30.01 mm, the width of speaker opening 112 is 13.04 mm, the width of port cover 110 is 13.8 mm, the width of port cover 108 is 6.1 mm, and the height of port covers 108 and 110 is 8.1 mm.

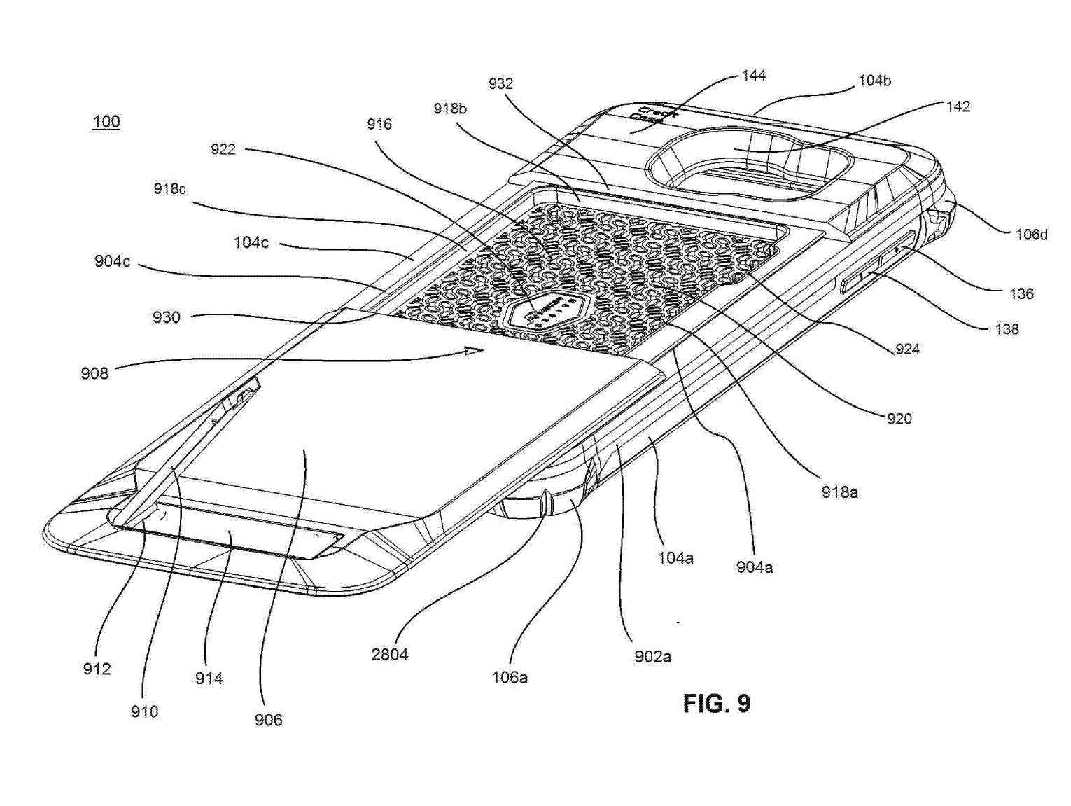

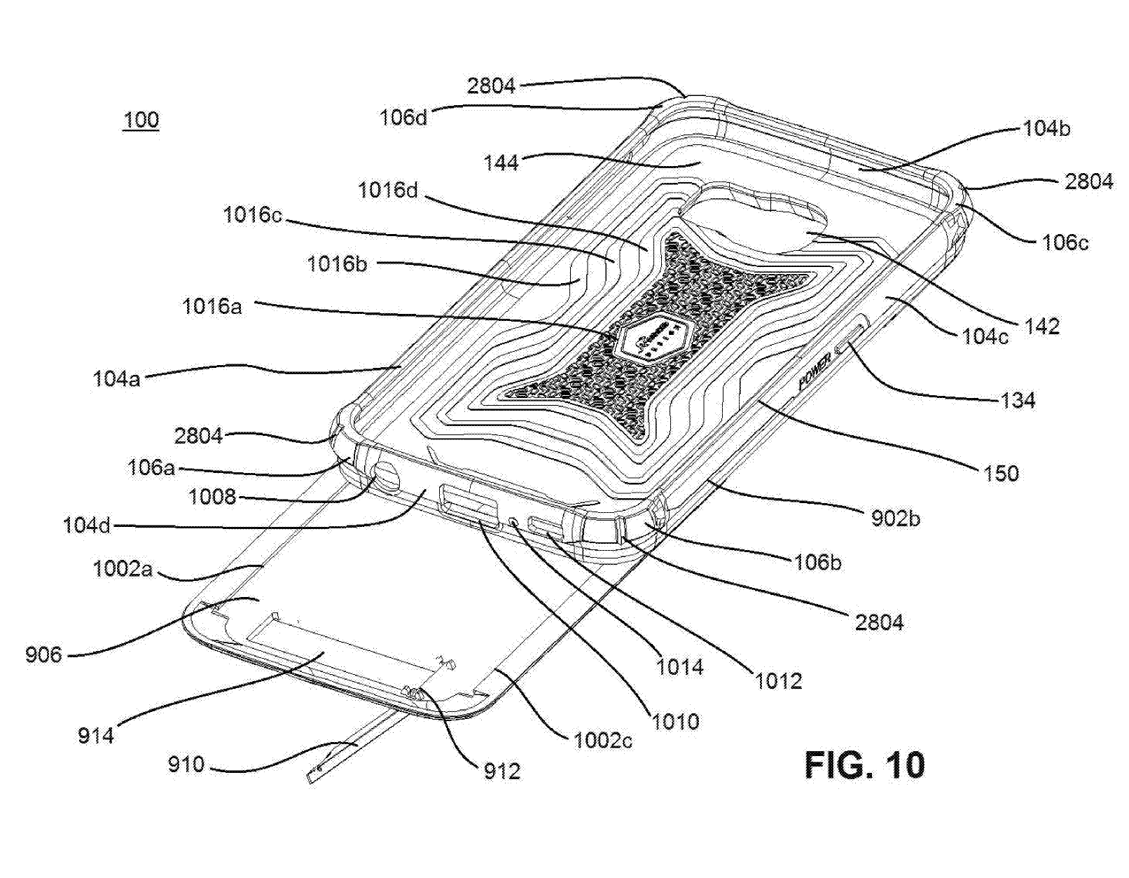

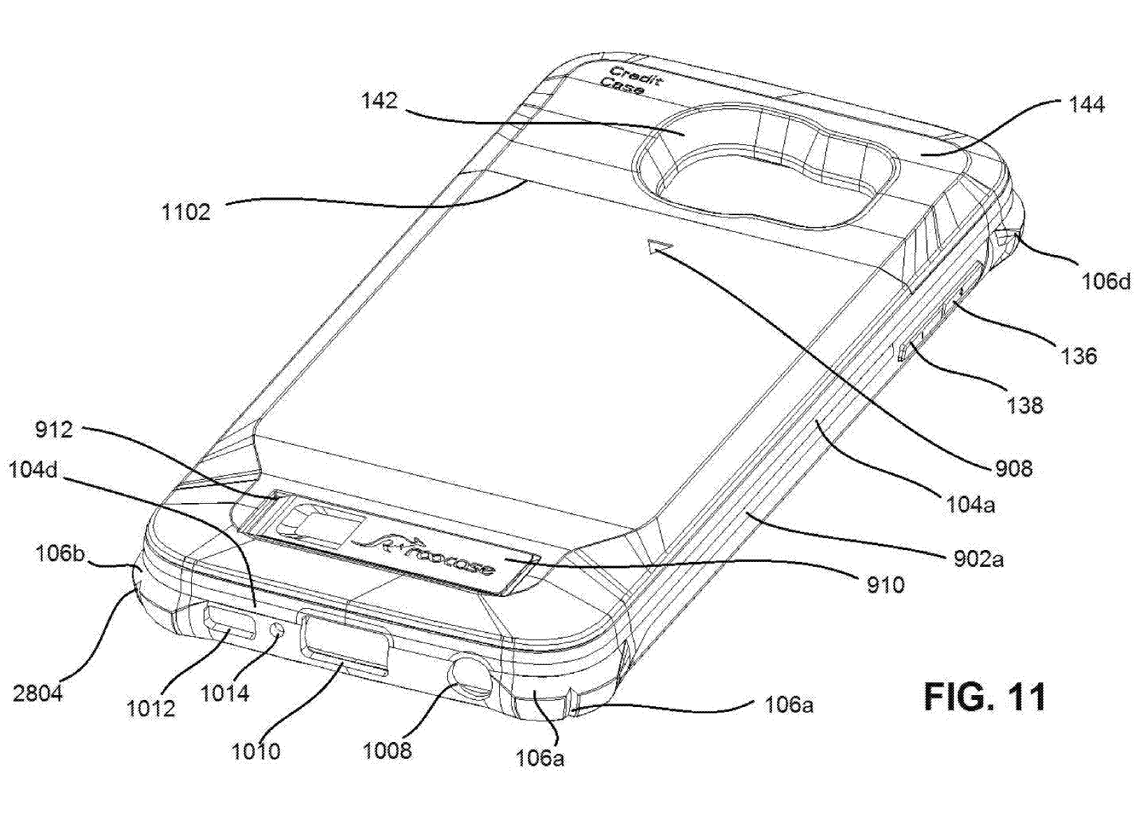

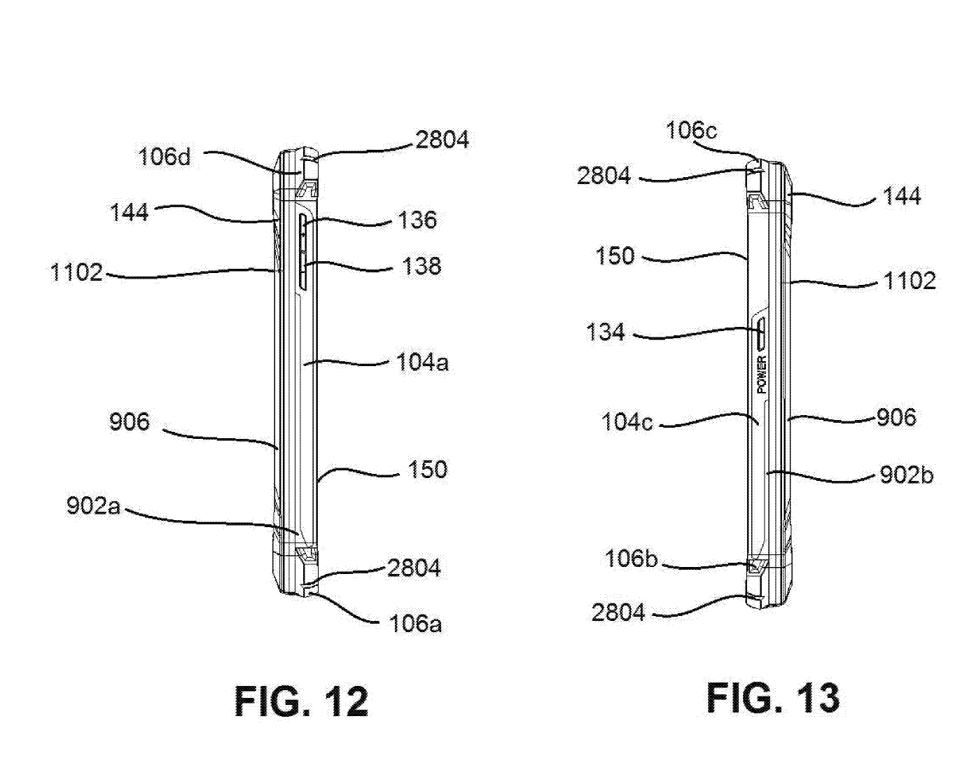

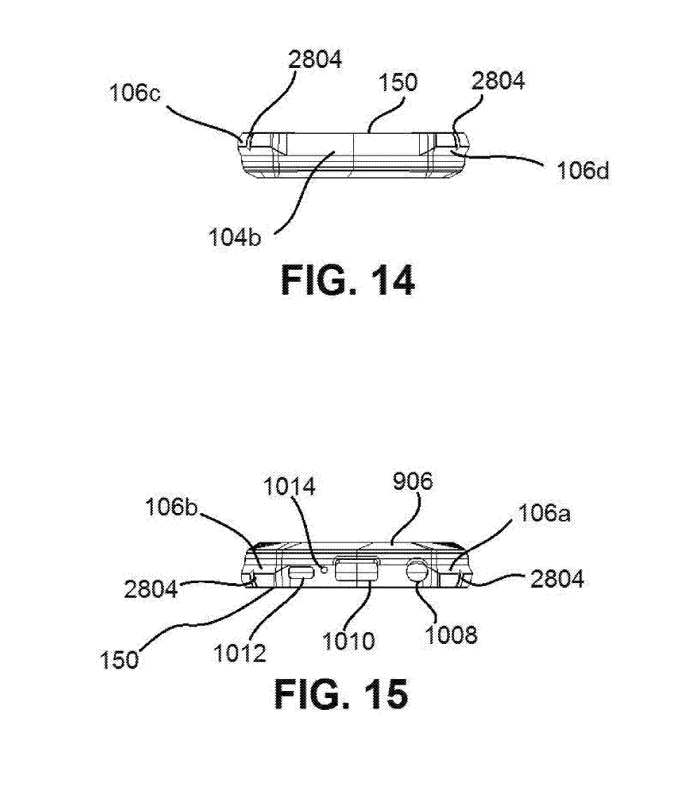

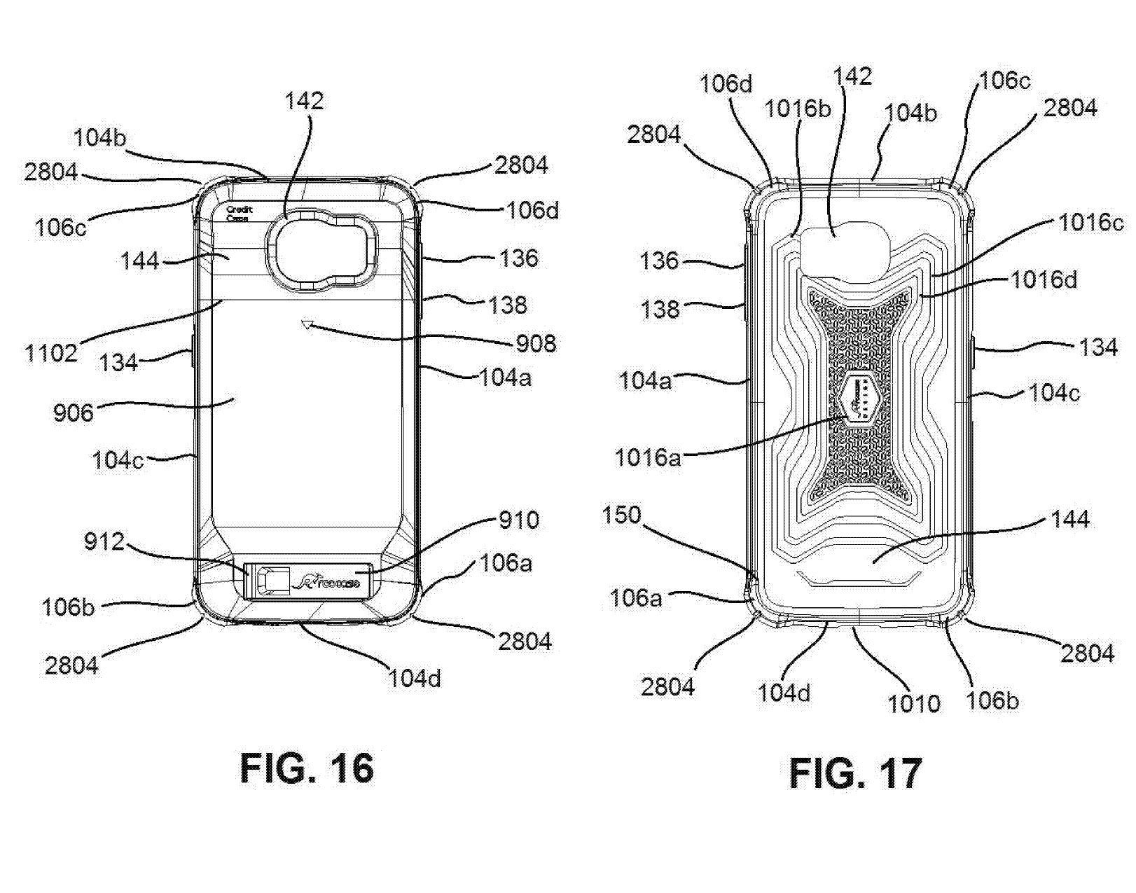

Referring to FIGS. 9-17, a second embodiment of the inventive protective cover 100 is illustrated. In this embodiment, cover 100 is provided with a slideable cover 906 that attaches to rear panel 144. The slideable cover 906 may be slid to open or closed positions to reveal or conceal a storage cavity 916 that is formed between slideable cover 906 and rear panel 144, and bounded by cavity walls 918a, 918b, 918c, and 918d (not shown, but parallel to and opposite wall 918b). FIGS. 9 and 10 illustrate cover 100 with slideable cover 906 and kickstand 910 both in open positions. FIGS. 11-17 illustrate cover 100 with slideable cover 906 and kickstand 910 both in closed positions.

Referring to FIGS. 9-17, a grip 902a or 902b may be provided extending along one or more sidewalls 104a-d to enhance a user's ability to grip the cover 100. Grips 902a and 902b may be formed of a flexible material, such as TPU, that has a less slippery surface than the material forming other portions of the case. Grips 902a and 902b may be flush with the profile of the relevant sidewall, or may protrude slightly from the sidewalls to provide a larger surface area for interaction with the digits of the user such that the friction between the user's digits and grip 902a or is 902b is increased. Additionally, grip 902a or 902b may reduce the possibility that the case will slip when used in conjunction with kickstand 910 to prop the case at an angle to a surface upon which the case is placed. Additional grips (not illustrated) of the same type may be formed as part of the sidewalls 104b or 104d. Rails 904a and 904c are provided to attach slideable cover 906 to rear panel 144 by interlocking with rails 1002a and 1002c in a slideable fashion. This will allow slideable cover 906 to be moved into an open position that provides access to a cavity 916, or into a closed position that conceals cavity 916. It is preferable that the cover edge 930 be flush with the top edge of wall 932 when the slideable cover 906 is closed, thereby providing a measure of concealment to the cavity 916.

Providing rails for opening and closing slideable cover 906 is preferable to providing a hinged opening, because the slidable mechanism permits protective cover 100 to retain a significant portion of its stiffness when the slidable cover 906 is open, thereby facilitating the use of kickstand 910 when slideable cover 906 is in either the open or closed position. If, however, slideable cover 906 was hinged, it may not be possible to use kickstand 910 when slideable cover 906 was rotated about the hinge to an open position. Note, however, that forming the device with a hinged cover to conceal cavity 916 falls within the scope of the inventive concepts discussed herein. But it may not be possible to use kickstand 910 while a hinged cover is in an open position revealing cavity 916.

Kickstand 910 is attached by pivot 912 to slideable cover 906 at the distal end of slidable cover 906 from sidewall 104b. Pivot 912 may be located within recess 914. Recess 914 may extend partially or completely through slideable cover 906. When it is closed, kickstand 910 should preferably life flush with the outer surface of slideable cover 906. When it is opened, kickstand 910 provides the ability to prop the protective cover 100 at an angle, rather than laying it flat on its front or back. This allows a user of protective cover 100 to view content on an inserted electronic device at a desirable angle without holding the device. For example, a user of cover 100 may find it preferable to view video content with an inserted electronic device when cover 100 is propping the device at an angle to a table by using kickstand 910.

A grip 908 may be formed on the side of slideable cover 906 that is opposite cavity 916. The grip 908 may be formed to enhance the user's ability to manipulate the slideable cover with a fingertip. Grip 908 may be formed as in a depression or other indentation in the surface of slideable cover 906. As an alternative embodiment, grip 908 may be formed as a protrusion from the surface of slideable cover 906. In another embodiment, grip 908 may be formed by using a relatively small deposit of flexible material, which will provide an increased amount of friction when a user attempts to slide cover 906 open using a finger.

A cavity 916 is provided and is defined by cavity walls 918a, 918b, 918c, and 918d (not shown), as well as slideable cover 906 and flexible lining 920. Preferably the cavity 916 is formed with a shape that allows for storage of a plurality of cards of a standard size, such as credit cards, debit cards, identification cards, or other cards. In a preferred embodiment, the cavity 916 is sized to hold one to three standard-sized credit cards. The cavity 916 may also be formed to allow the storage of money, keys, memory cards, or other possessions that a user may wish to conceal. A finger grip 924 is provided on cavity wall 918a to allow users to insert a finger tip, stylus, or small object at the perimeter of a card to remove the card from the cavity 916. Finger grip 924 may be provided, in the alternative, on cavity wall 918c or 918b. Cavity 916 may be formed from or lined on its bottom surface with a flexible lining 920. However the bottom of the cavity may be formed from the stiff material without a flexible lining. The flexible lining is desirable to retain the inserted cards without excessive shaking, rattling, or shifting during use of protective cover 100. A buffer chamber 922 maybe provided within cavity 916. Buffer chamber 922 maybe bounded by a raised portion of flexible lining 920 such that when a card is inserted, a small buffer chamber will be formed between the card and flexible lining 920, to provide additional shock relief in the event of a shock or to raise the card slightly above the surface of flexible lining 920 to ease a user's ability to remove an inserted card.

Also illustrated is a wall 932, which forms a stop for slideable cover 906 when slidable cover 906 is closed to conceal cavity 916. Preferably the outer contour of slideable cover 906 will conform to the other contour of wall 932 to provide for concealment of cavity 916 when slideable cover 906 is in a closed position. However, it remains within the scope of this invention to provide a slideable cover 906 that does not entirely conceal cavity 916. Additional features illustrated in FIG. 9 are cutout 142 and divot 2804. Cutout 142 is provided to allow normal functionality of, for example, a camera and microphone that are provided on the rear panel of an inserted electronic device.

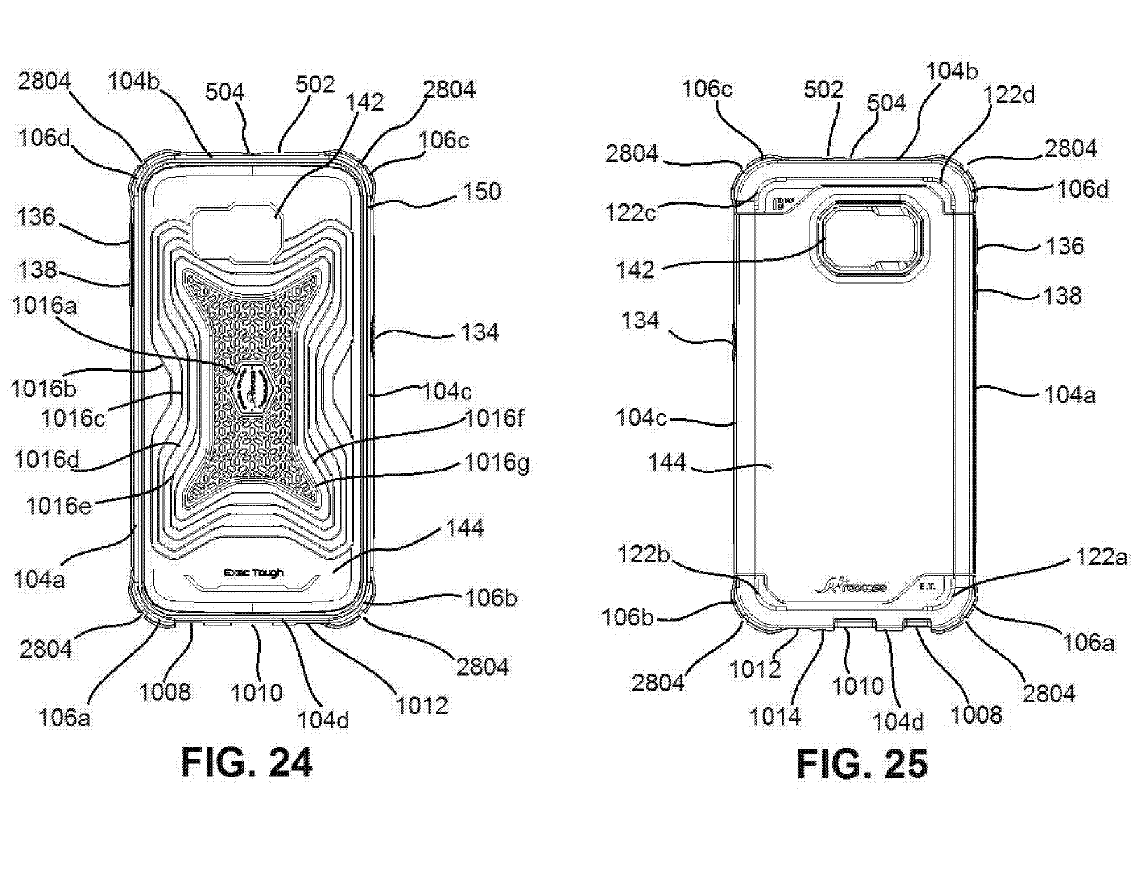

Referring to FIGS. 10, 17, 18 and 24, a series of buffer chambers is provided within the interior portion of cover 100 on the surface of rear panel 144. Such buffer chambers may be formed using the surface of panel 144 in conjunction with buffer chamber rims 1016a, 1016b, 1016c, and 1016d, in the rear surface of an inserted electronic device. When an electronic device is inserted in cover 100, the combination of buffer chamber rims, rear panel 144 surface, and rear surface of the inserted electronic device will form small pockets of air between the electronic device and the surface of rear panel 144. Such pockets of air will allow for a buffer zone and a distribution of shock in the event that cover 100 experiences a shock to the rear portion of the cover. The quantity, size and shape of such buffer chambers may be varied. Additionally, as illustrated in the exemplary embodiment, a series of buffer chambers may be nested. In the alternative, the buffer chambers need not be nested and may be arranged laterally to other buffer chambers rather than within another buffer chamber. Moreover, as is illustrated in FIG. 10, buffer chamber rims 1016b and 1016c intersect cutout 142 such that these rims do not form a complete wall about the buffer chambers that each rim defines. Accordingly, one of ordinary skill in the art should understand that the buffer chambers may be completely enclosed or partially enclosed. Buffer chamber rims may be formed with sidewalls that are perpendicular to the surface of rear panel 144. However, in a preferred embodiment, the sidewalls of the buffer chamber rims are beveled with respect to the surface of rear panel 144 and the buffer chamber rims are preferably formed following a path with multiple oblique angles, rather than straight paths with right or acute angles, for better impact stability, internal scratch resistance, and shock absorption.

As illustrated, between buffer chamber rim 1016a and the next larger buffer chamber rim, a pattern of flexible material may be formed, to enhance the ability of the rear panel 144 to retain an inserted electronic device at a single position and prevent slippage of the device within the cover 100. Such a pattern may be, as shown, a composite raised key-link layout, which is a series of links similar to chain links or offset ellipses. However this specific pattern is not required, and other known patterns that provide such enhanced traction, may be substituted while remaining within the scope if the disclosed invention. Additionally, such a pattern may also be formed in parts or all of flexible lining 920. As illustrated in, e.g., FIG. 9, a composite raised key-link layout may be formed between buffer chamber 922 and cavity walls 918a-d.

In this embodiment, it may be desirable to provide a plurality of port openings, such as port openings 1008, 1010, 1012, and/or 1014. Port opening 1008, for example, may be provided to allow a headphone jack to be inserted into a headphone jack receptacle within an inserted electronic device. Port opening 1010, for example, may be provided to allow insertion of a charging cable connector into a charging port of an inserted electronic device. Port opening 1014 may be provided to allow access to a microphone of the device, such that the microphone is not excessively muffled by the presence of cover 100. And port opening 1012, for example, may be provided to allow access to a speaker of an inserted electronic device, such that the sound emanating from the speaker is not excessively muffled.

It may also be desirable in various embodiments to form the button covers, such as button covers 134, 136 and 138 using a stiff material such as acrylonitrile butadiene styrene (“ABS”) plastic, which may also have a metallic coating. Using such material may enhance the user's experience with the protective cover, as manipulation of a stiffer button cover may be more reminiscent of manipulation of a button on an electronic device than would manipulation of a flexible button cover. Such material may also provide for a better response when a button cover is manipulated. When using a stiff material such as ABS, it may be desirable to co-mold the button covers with the flexible material of the sidewall or to form the sidewall and then insert the button covers later.

Referring now to FIGS. 11, 12, 13 and 16, a contact line 1102 is shown, indicating the intersection of slideable cover 906 and wall 932. As is illustrated, in the preferred form of this embodiment, the slidable cover 906 aligns flush with wall 932 when slideable cover 906 is in a closed position. Also, as illustrated in FIG. 11, kickstand 910 may be rotated about pivot 912 into recess 914 such that the outer surface of kickstand 910 is flush with the outer surface of slidable cover 906.

Referring to the embodiment of FIGS. 9-17, in a preferred embodiment, cover 100 is 75.37 mm wide and 146.83 mm long, with a depth of 14.88 mm, while the height and width of port opening 1008 are 8.89 mm and 8.96 mm respectively, the width of kickstand 910 is 40.79 mm, the width of button cover 134 is 10.82 mm, the distance from one end of button cover 136 to the opposite end of button cover 138 is 25.08 mm, the height and width of port opening 1012 are 3.79 mm and 8.17 mm respectively, the height and width of port opening 1010 are 6.93 mm and 13.68 mm respectively, and the width of port opening 1014 is 2.17 mm.

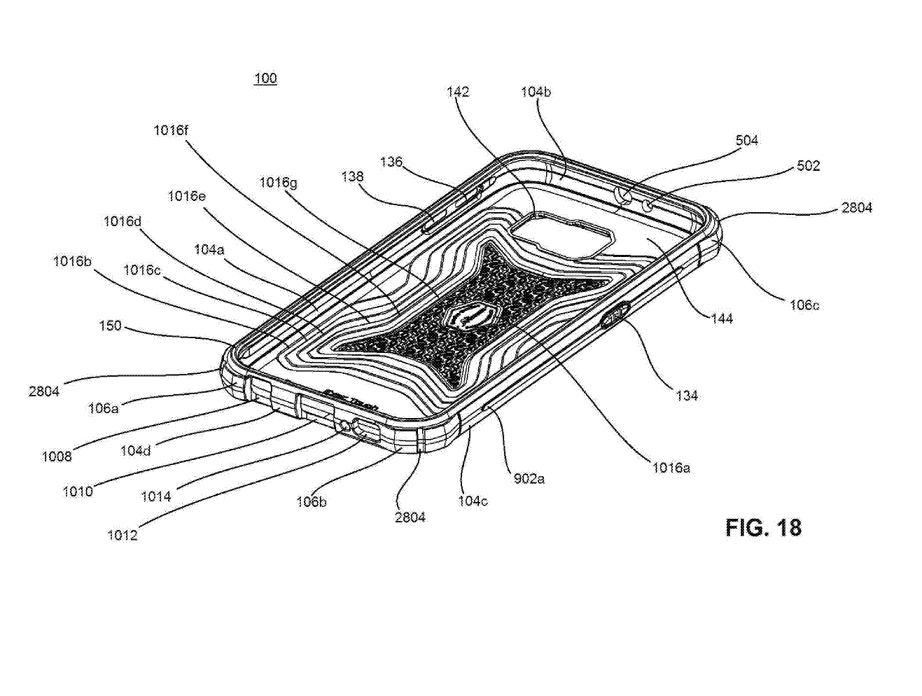

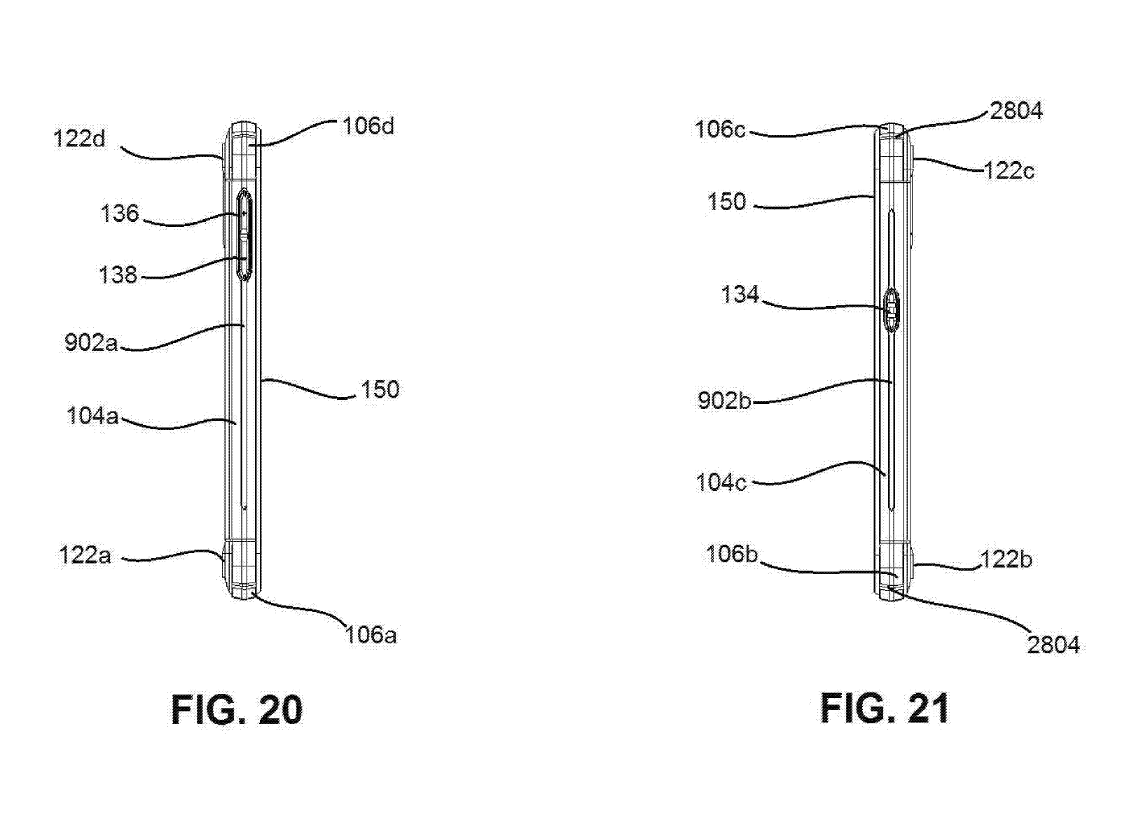

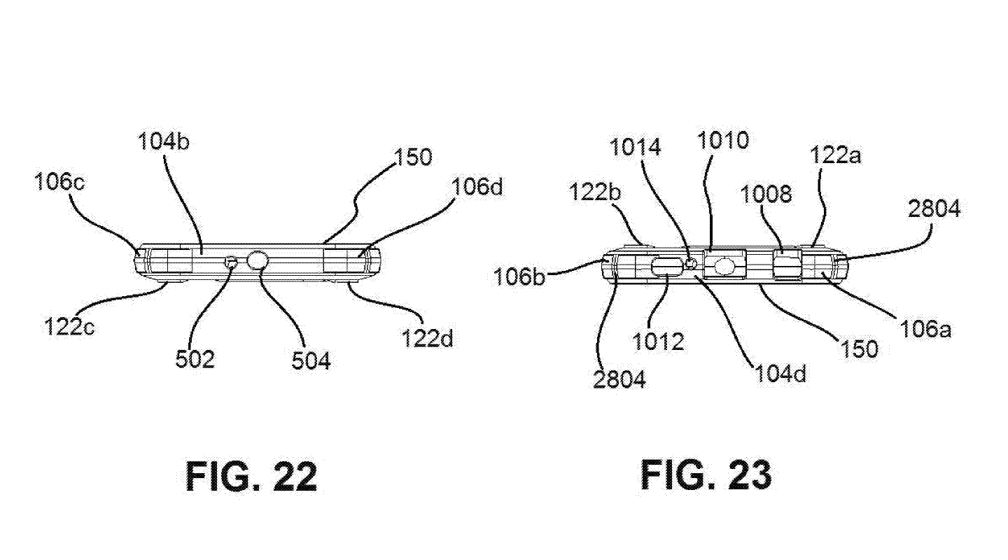

Referring now to FIGS. 18-25, a third embodiment of the inventive protective cover 100 is illustrated. In this embodiment, cover 100 is provided with four corner bumpers 106a-d. Cover 100 may be co-molded using both a flexible material and a stiff material to provide a single-piece protective cover that is both shock-absorbant and stiff enough to retain its form in the course of ordinary usage. In this third embodiment, the protective cover is illustrated without either a slidable rear cover or a front panel. However, this illustration should not be deemed to exclude the use of either a slidable rear cover or a transparent front panel with this embodiment.

Referring specifically to FIG. 18, additional buffer chamber rims 1016e, 1016f, and 1016g are illustrated, showing that additional nested buffer chambers may be added to the interior portion of rear panel 144. As is illustrated in FIG. 18, cutout 142 is provided with an interior rim of a flexible material, such that each of buffer chambers bounded by buffer chamber rims 1016b, 1016c, and 1016d, may form a portion of a sealed buffer chamber, rather than an unsealed buffer chamber.

Another feature of the third embodiment, is that grips 902a and 902b are illustrated as protruding slightly from the profile of sidewalls 104a and 104c, to enhance a user's ability to grip the protective cover without slippage. In embodiments such as this, grips 902a and 902b may be formed from a flexible material that is co-molded with the stiff material that forms other portions of sidewalls 104a and 104c. Co-molding permits the formation of a single-piece protective cover 100 that has both flexibility where desired and stiffness where desired, providing for the user the benefit of lighter weight and less bulkiness due to the ability to eliminate connecting features such as interlocking ridges in a co-molded product.

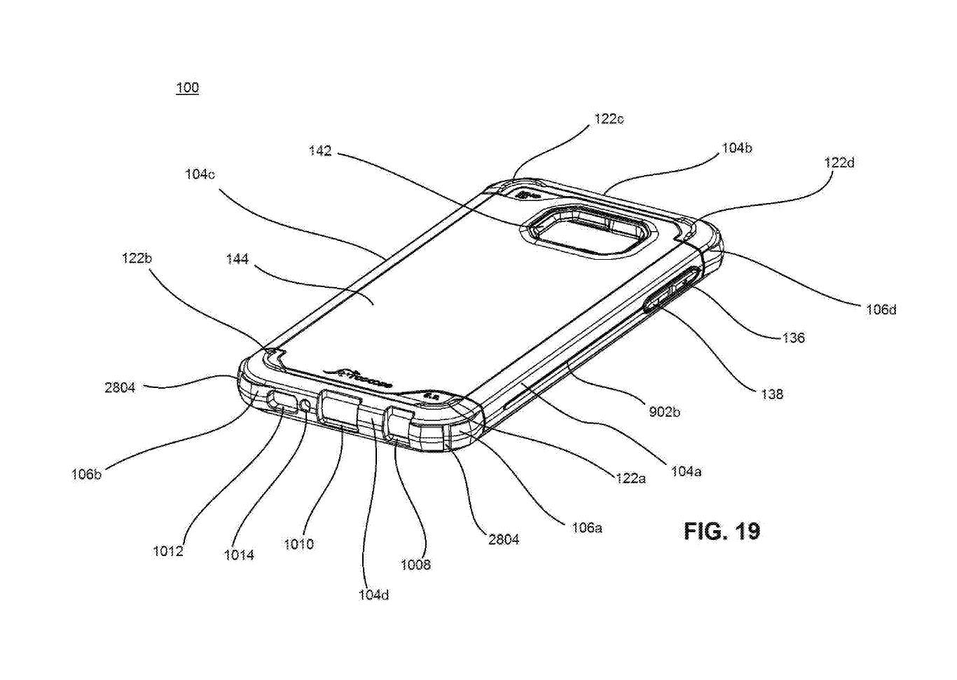

Referring to FIG. 19, it may be seen that a plurality of ridges 122a, 122b, 122c, and 122d may be formed on or near the rear panel 144 of the cover 100, to raise the rear panel 144 of the cover 100 from a flat surface when the cover 100 is placed on such a flat surface. This may be desirable to prevent scratches to the rear panel 144, which may be an opaque panel formed of stiff material such as PC or a transparent material such as acrylic.

Referring to FIGS. 18-25, the screen frame guard comprising beveled edge 124 and raised ridge 150 may be formed about the entire periphery of the area in which the screen of an inserted electronic device would be visible. This screen frame guard will provide for protection of a screen with respect to strikes as well as providing edge and corner protection to an inserted electronic device.

In the third embodiment, it is preferable to form the ridges 122a, 122b, 122c, and 122d, such that they extend at least 0.7 mm from the rear of the rear panel 144. In addition, the cutout 142 may also extend outward from the rear panel 144, for example, to provide protection to a protrusion such as a camera from the rear of an inserted electronic device. In a preferred embodiment, the edge of the cutout 142 will protrude approximately the same distance as the ridges 122a-d.

Referring now to FIGS. 26 and 27, both figures show cross-sections of various embodiments of sidewall 104c. As illustrated, it should be clear to one of ordinary skill in the art that the profile of the sidewall is not meant to be limited to a vertical wall, but can include various profiles based upon aesthetics, desired functionality, and/or the shape of the device for which protection is desired.

Referring to FIG. 26, it can be seen that the inner profile of sidewall 104c may be approximately semi-circular or otherwise curved to accommodate the sidewall profile of an inserted electronic device, while the rear panel 144 is preferably flat or slightly curved to accommodate the rear profile of the device, and may include features corresponding to protrusions or depressions in the device profile. For example, rear panel 144 extends approximately horizontally defining a rear plane of the device 2614. Rear panel 144 need not be flat and need not intersect the rear plane 2614 at all points, but may be formed to conform to the rear panel or rear display of an inserted electronic device. Thus, rear plane 2614 provides an approximation of the shape of rear panel 144 and a point of reference for connection and protrusion of the sidewalls, e.g., sidewall 104c, which protrudes in a direction orthogonal to the rear plane 2614, meaning that a line segment drawn orthogonally from the plane will intersect portions of the sidewall 104c. But rear plane 2614 need not intersect panel 144 at all points within the perimeter of the cover 100. Rear panel 144 may comprise a stiff layer 2604, which may be formed of one or more stiff materials such as PC or acrylic, and a flexible layer 2602, which may be formed using a flexible material such as TPU or silicone. As illustrated, the flexible layer 2602 is designed to be positioned, at least in part, against the rear panel of an inserted electronic device. And the stiff layer 2604 is designed to face the environment external to protective cover 100 and may extend seamlessly into the sidewalls, e.g., sidewall 104c. However, it may be desirable in certain embodiments to provide for another flexible layer (not illustrated) facing the environment. This additional flexible layer may provide various advantages such as shock absorption, gripability, or other advantages. Such a layer may completely or partially cover the exterior of rear panel 144.

Flexible layer 2602 maybe formed to conform to the rear of an inserted electronic device, and may extend seamlessly into portions of sidewall 104c. In the illustrated embodiment, flexible layer 2602 extends into sidewall 104c and extends orthogonally to rear plane 2614 beyond button cover 134 to form the upper portion of sidewall 104c including a retaining lip 2610, a flexible portion 2606, a beveled edge 2608, and raised ridge 150. As illustrated in this cut-away, it appears that button cover 134 bisects flexible layer 2602 such that the upper portion and lower portion are separate. However, in portions of sidewall 104c that are not bisected by button cover 134, the upper portion including elements 2606, 2608 and 2610 are connected with the lower portion of flexible layer 2602 by a continuous segment of flexible material. In embodiments such as that illustrated in FIG. 26, stiff layer 2604 maybe co-molded with flexible material 2602. A separate portion of stiff layer 2604 is illustrated above button cover 134 and may be connected contiguously with the portion of stiff material that is used to form rear panel 144 and other stiff portions of the device, which are co-molded with the flexible material.

As shown in FIG. 26, retaining lip 2610 may be a flexible portion that may be compressed, bent, or otherwise manipulated upwards or outwards for purposes of inserting or removing an electronic device. Retaining lip 2610 will then, after insertion, revert to its original shape or a close approximation of the original shape and participate in retaining an electronic device within protective cover 100. As is illustrated, it may be desirable to form a beveled edge 2608 or rounded edge (not illustrated) of the flexible material, such that the front panel of an inserted electronic device will be protected when the cover is laid or dropped on a flat surface, as is described above with respect to beveled edge 124. Similarly, raised ridge 150 may be formed using the flexible material such that it will function in the fashion described above. When an electronic device is inserted in cover 100, it is desirable that the contact portion 2612 of button cover 134 be located proximate to a button or key of the device, such that manipulation of the button or key is possible through actuation or manipulation of button cover 134 without the need to remove cover 100. Button cover 134 may be hinged, may be mounted entirely with a surround of flexible material, or may be attached in other known manners that will allow button cover 134 to move sufficiently to interact with a button or key of an inserted electronic device. As illustrated, contact portion 2612 is concave. But, contact portion 2612 may be convex or have other form factors that provide for interaction with the relevant button or buttons of an inserted device.

Referring now to FIG. 27, an exemplary cross-section of another embodiment of the sidewall according to the inventive protective cover is disclosed. In this embodiment, it may be seen that both a front panel 102 and a rear panel 144 are present. The front panel 102 defines a front plane 2716. And the rear panel 144 defines a rear plane 2714. It is not required that either of the panels are co-extensive with the relevant plane or intersect the plane at all points within the perimeter of the cover 100. However, in the example illustrated in FIG. 27, both front panel 102 and rear panel 144 are substantially planner and intersect the relevant planes at all points without cutouts that are within the perimeter of the device 100.

In this embodiment, at least a portion of sidewall 104c extends orthogonally from both the rear plane 2714 and the front plane 2716, meaning that a line segment drawn orthogonally from either plane will intersect portions of the sidewall 104c. The invention disclosed herein also encompasses embodiments in which the rear plane 2714 and front plane 2716 are not parallel, such that the sidewalls may extend orthogonally from one plane, but at an acute or obtuse angle to the other plane. The sidewall 104c comprises a stiff inner sidewall 2704 and a flexible outer sidewall 2705, which may correspond to stiff inner sidewall 105b and flexible outer sidewall 105a as described above. In this embodiment, the stiff sidewall 2704 and the flexible sidewall 2705 may be formed separately with inter-locking features, or they may be co-molded such that it is difficult to separate the flexible and stiff portions of sidewall 104c, and interlocking features are not necessary. If co-molded, it may be desirable to form the cover 100 in such a manner as to allow easy detachment of front panel 102 or rear panel 144 to accommodate insertion or removal of an electronic device. As illustrated, a retaining slot 2703 retains rear panel 144 within sidewall 104c at the intersection of the sidewall 104c and the rear panel 144. Retaining slot 2703 may extend about the entire perimeter of rear panel 144 or about a portion of the perimeter sufficient to retain panel 144 and provide any desired seal against the external environment. This is a preferred manner of attaching the rear panel 144 to the sidewall, e.g. 104c. However it is not intended to be limiting. Other known matters of attachment may be used, such as forming the rear panel 144 of a contiguous portion of the same material used to form flexible sidewall 2705. Or it may be possible to glue, adhere, or otherwise retain or attach the rear panel 144 to the sidewall 104c while remaining within the intent of the disclosed invention. Also illustrated on sidewall 104c is a slot 132c, which may be added to the sidewall for purposes of enhancing the ability of the user to grip cover 100. As illustrated in FIG. 27, slot 132c has a trench like appearance with walls that are substantially orthogonal to its base. As described above, slot 132c may be formed with different form factors.

As illustrated in FIG. 27, front panel 102 is retained within stiff sidewall 2704 via retaining slot 2702. Retaining slot 2702 may extend about the entire perimeter of rear panel 102 or about a portion of the perimeter sufficient to retain panel 102 and provide any desired seal against the external environment. As indicated with respect to retaining slot 2703 and rear panel 144, this is one manner of retaining the front panel 102 while remaining faithful to the intent of the disclosed invention. However, other known manners of retention or adhesion are permissible without departing from the scope of the invention. In the illustrated exemplary embodiment, flexible sidewall 2705 includes a ridge 2710, while stiff sidewall 2704 is formed to include a ridge 2708. Ridges 2708 and 2710 maybe interlocking, such that when stiff sidewall 2704 is inserted within the portion of the cover 100 formed by flexible sidewall 2705 and rear panel 144, ridge 2708 and ridge 2710 may be manipulated to interlock, thereby retaining stiff sidewall 2704 in a position within and adjacent to flexible sidewall 2705. Interlocking ridges 2708 and 2710 may extend about the entire perimeter of front panel 102 or may extend about only a portion or portions of front panel 102, as long as the ridges extend a sufficient distance about the perimeter that they are able to remain interlocked during ordinary use of the cover 100. When stiff sidewall 2704 and flexible sidewall 2705 are in close proximity and interlocked, seam 126 may be visible from the top of the cover 100. In the illustrated embodiment, rear panel 144 is attached to flexible sidewall 2705, while front panel 102 is attached to stiff sidewall 2704. However, one of ordinary skill will understand that front panel 102 may instead be attached to flexible sidewall 2705 and rear panel 144 attached to stiff sidewall 2704 without departing from the scope of the disclosed invention. If formed in this manner, it would be preferable to invert the positioning of ridges 2710 and 2708 so that they remain interlocked without rear panel 144 in a position to assist with retention of stiff sidewall 2704 within flexible sidewall 2705.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A protective cover for an electronic device, comprising:
a first sidewall;
a second sidewall;
a corner bumper joining the first sidewall to the second sidewall,
wherein the corner bumper comprises a flexible material layer configured to form a cavity between the flexible material layer and an inserted electronic device when an electronic device is inserted in the cover, and
at least one interior wall formed in the cavity to divide the cavity into a plurality of air pockets.

2. The cover of claim 1, further comprising:
a second interior wall formed in the cavity to divide the cavity into at least three air pockets.

3. The cover of claim 1, wherein
the interior wall does not extend from the flexible material layer to an electronic device when such electronic device is inserted in the cover and the bumper is not deformed.

4. The cover of claim 1, further comprising:
a third sidewall arranged parallel to the first sidewall;
a fourth sidewall arranged parallel to the second sidewall;
a rear panel attached on the perimeter of the panel to each of the first, second, third and fourth sidewalls.

5. The cover of claim 4, further comprising:
a second corner bumper joining the second sidewall to the third sidewall;
a third corner bumper joining the third sidewall to the fourth sidewall;
a fourth corner bumper joining the fourth sidewall to the first sidewall;
wherein each of the second, third and fourth corner bumpers comprises a flexible material layer configured to form a cavity between the flexible material layer and an inserted electronic device when an electronic device is inserted in the cover; and
at least one interior wall formed in the cavity to divide the cavity into a plurality of air pockets.

6. A protective cover for an electronic device, comprising:
an inner case formed of a stiff material; and
an outer case formed of a flexible material;
wherein the inner case comprises first and second pairs of parallel stiff sidewalls and a rear panel arranged such that both pairs of stiff sidewalls extend in a direction orthogonal to a rear plane,
wherein the rear panel is attached to each of the stiff sidewalls at an intersection of the stiff sidewall and the rear plane,
wherein the longest dimension of the first pair of stiff sidewalls is arranged orthogonally to the longest dimension of the second pair of stiff sidewalls; and
wherein the outer case comprises first and second pairs of parallel flexible sidewalls and a front panel arranged such that both pairs of flexible sidewalls extend in a direction orthogonal to a front plane,
wherein the front panel is attached to each of the flexible sidewalls at an intersection of the flexible sidewall and the front plane,
wherein the longest dimension of the first pair of flexible sidewalls is arranged orthogonally to the longest dimension of the second pair of flexible sidewalls, and
wherein the outer case is configured to surround the stiff sidewalls, and each of a plurality of the flexible sidewalls is configured to interlock with a corresponding one of the stiff sidewalls such that, when interlocked, a cavity capable of enclosing an electronic device is formed between the front panel and the rear panel and between each pair of stiff sidewalls.

7. The protective cover of claim 6, wherein:
the rear panel is transparent.

8. The protective cover of claim 7, wherein
the front panel is transparent.

9. The protective cover of claim 6, further comprising:
a corner bumper formed of the flexible material,
wherein the corner bumper joins a first flexible sidewall from the first pair of flexible sidewalls to a second flexible sidewall from the second pair of sidewalls,
wherein the corner bumper comprises a flexible material layer configured to form a cavity between the flexible material layer and an inserted electronic device when an electronic device is inserted in the cover; and
at least one interior wall formed in the cavity to divide the cavity into a plurality of air pockets.

10. The protective cover of claim 9, further comprising:
a second corner bumper joining a third flexible sidewall from the first pair of flexible sidewalls to the second flexible sidewall from the second pair of sidewalls;
a third corner bumper joining the first flexible sidewall from the first pair of flexible sidewalls to a fourth flexible sidewall from the second pair of sidewalls;
a fourth corner bumper joining the third flexible sidewall from the first pair of flexible sidewalls to the fourth flexible sidewall from the second pair of sidewalls;
wherein each of the second, third and fourth corner bumpers comprises a flexible material layer configured to form a cavity between the flexible material layer and an inserted electronic device when an electronic device is inserted in the cover; and
at least one interior wall formed in the cavity to divide the cavity into a plurality of air pockets.

11. A protective cover for an electronic device, comprising:
first and second pairs of parallel sidewalls;
a transparent rear panel connected to each of the sidewalls;
a transparent front panel connected to each of the sidewalls;
wherein the rear panel comprises a scratch-resistant first material;
wherein the front panel is configured to permit touch interaction through the front panel when a touch screen is located adjacent to the front panel;
wherein the rear panel is arranged parallel to the front panel with a gap between panels; and
wherein the gap is sufficiently large to permit the panels to enclose an electronic device having a touch screen.

12. The protective cover of claim 11, wherein
the rear panel comprises a transparent acrylic material.

13. The protective cover of claim 11, wherein
the front panel comprises transparent polyethylene terephthalate.

14. The protective cover of claim 11, further comprising:
a beveled rim surrounding the perimeter of the front panel.

15. The protective cover of claim 11, further comprising:
a beveled rim formed of a flexible material;
wherein each sidewall comprises an inner stiff sidewall and an outer flexible sidewall;
wherein the bevel is connected to a plurality of the flexible sidewalls; and
wherein each inner sidewall is configured to interlock with a corresponding outer sidewall.

16. A protective cover for an electronic device, comprising:
a first and a second set of parallel sidewalls;
a rear panel attached to each of the sidewalls on a first side, the rear panel having a cavity formed therein on a second side opposite the first side;
a slideable panel moveably connected to the rear panel,
wherein the slideable panel is configured to completely cover the cavity in a first position and at least partially expose the cavity in a second position.

17. The cover of claim 16, wherein
the cavity is sufficiently large to enclose a plurality of credit cards.

18. The cover of claim 16, wherein
the rear panel comprises polycarbonate plastic;
the slideable panel comprises polycarbonate plastic; and
the cavity is at least partially lined with thermoplastic polyurethane plastic.

19. The cover of claim 16, further comprising:
a kickstand, wherein the kickstand is rotatably coupled to the slideable panel.

20. The cover of claim 16, wherein
the sidewalls comprise polycarbonate plastic co-molded with thermoplastic polyurethane plastic.
